(19) United States
(12) Patent Application Publication
(10) Pub. No.: US 2006/0077917 A1
(43) Pub. Date: Apr. 13, 2006

(54) Architecture and method for enabling use of wireless devices in industrial control

(75) Inventors: Jagadeesh Brahmajosyula, Guntur (IN); Vinayak S. Kore, Bangalore (IN); Srivastava Namburi, Hubli (IN)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Honeywell International Inc.

(21) Appl. No.: 10/960,268

(22) Filed: Oct. 7, 2004

(51) Int. Cl. H04L 12/56; H04L 12/28; H04J 3/24; H04B 7/00

(52) U.S. Cl. 370/310; 370/401

(57) ABSTRACT

Wireless devices are added to existing hardwired process control systems. In one embodiment, a wireless interface unit or module is used to provide an interface between wireless sensors and an existing hardwired bus or network. The wireless interface unit may be used at multiple different stages of the network, and provides protocol abstractions in one embodiment to provide reliability and quality of service consistent with devices in the existing network.

### FIELD

The present invention is related to industrial control, and in particular to a wireless device enablement architecture for industrial control.

### BACKGROUND

A fieldbus network consists of several field devices, such as a sensors and actuators. These field devices may be connected to form a network. Field devices are connected by means of a twisted pair wire to form a bus, which may also be a twisted pair. The connections and twisted pairs may be any type of hardwired communication medium. Analog devices are coupled to input/output modules for conversion of the typical 4-20 mA signals they generate. In some instances the bus is also the source of power for the devices connected to it. These physical devices are linked to a backend host system or systems such as high-end controllers, either through linking devices or through input/output modules.

The devices are typically sensors or actuators used to monitor or control certain process variables of a plant or factory. Sometimes, it may be difficult to run wires to the devices, such as where the devices are located in hazardous locations, or are perhaps mounted on mobile and inaccessible equipment. Other times, there is a need to augment data provided by wired sensors.

Some prior methods of adding wireless communications to a fieldbus network utilize fieldbus devices with built-in wireless ports. The wireless port is coupled to a control room, and may be powered by a wired control network. It may also be accessed by hand-held wireless devices. A bridge may also be provided to couple control networks to the wireless devices. Devices in these methods are wired devices, and no provision is made for the situation where it may be difficult to conveniently wire devices.

### SUMMARY

A wireless interface device is provided for communicating with wireless devices. A protocol abstraction unit translates data between formats for the wireless interface devices and a hardwired bus. A communication stack coupled to the protocol abstraction unit and hardwired bus for emulating data communication through the hardwired bus which has a plurality of hardwired bus devices.

In one embodiment, a distributed process control system includes a plurality of first field devices for sensing a first information set corresponding to industrial process control parameters. The first field devices channel the first information set through a wired first channel. A plurality of second devices being characterized as wireless nodes, sense a second information set corresponding to the distributed process control parameters. The second devices are coupled to a plurality of first wireless transceivers to channel the second information set through at least one wireless channel to the wired first channel for augmenting the industrial process control pertaining to said distributed control system architecture. At least one host controller electronically accesses and processes primary information characterizing the distributed control system and secondary information corresponding to the first and second information sets. A network abstraction device is coupled to a least one second wireless transceiver wirelessly communicating with the first wireless transceivers. The network abstraction device may be configured to emulate a communication gateway.

### BRIEF DESCRIPTION OF THE DRAWINGS

FIG. 1 is a block diagram of a hardwired network of devices augmented with wireless devices according to an example embodiment.

FIG. 2 is a block diagram of an alternative hardwired network of devices augmented with wireless devices according to an example embodiment.

FIG. 3 is a block diagram of yet a further alternative hardwired network of devices augmented with wireless devices according to an example embodiment.

FIG. 4 is a block diagram illustrating multiple stages at which wireless devices may be added to a hardwired network of devices according to an example embodiment.

FIG. 5 is a block diagram of architecture of a fieldbus device according to an example embodiment.

FIG. 6 is a block diagram of an architecture of a fieldbus device with a wireless interface according to an example embodiment.

FIG. 7 is a block diagram illustrating addressing of wireless nodes coupled to a gateway according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

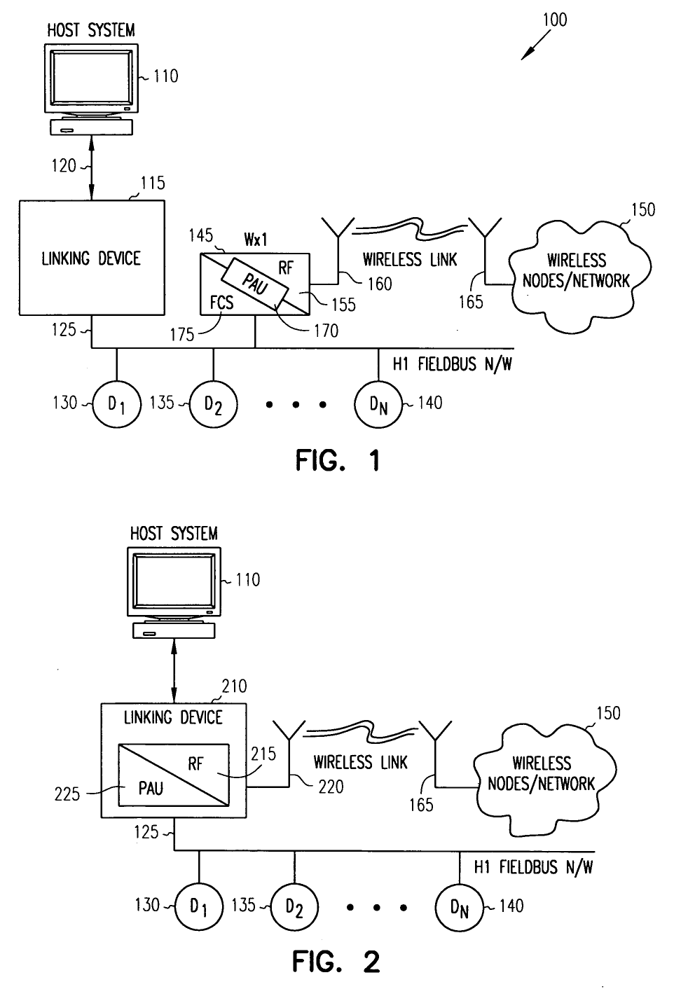

A system is shown in block diagram form generally at 100 in FIG. 1. The system 100 comprises a host system 110, such as a server that executes programming. A linking device 115 is coupled to the host 110 via a bus 120. The bus may be proprietary or open, and in one embodiment is a digital communication bus or High Speed Ethernet connection. Linking device 115 interfaces to a fieldbus 125, which couples multiple devices, such as sensors or actuators for example indicated at 130, 135 and 140. In one embodiment, the linking device 115 comprises an input/output module, and the fieldbus 125 comprises a twisted pair of wires. In further embodiments, multiple linking devices may be coupled to the host 110, with each of such linking device being further coupled to devices through fieldbuses. The linking device also may be configured as a bus master for underlying devices.

While a Fieldbus is desirably used in one embodiment, such as a H1 31.25 Kbps link, or H2 1 Mbps link, other fieldbusses may be used. The Fieldbus standard bus described in the FOUNDATION™ Fieldbus Specifications provides high reliability communications for devices. Power for the devices may also be carried via the Fieldbus. Other implementations, such as commercially available off the shelf (COTS) Ethernet versions may also be used, as well as other, fieldbus busses also can be used. Other busses having various protocols may be used, and are encompassed within the term “fieldbus”.

Devices 130, 135 and 140 are used in one embodiment to monitor certain process variables in a physical environment of a plant or a factory. A gateway characterized as a network abstraction device 145 is also coupled to the fieldbus 125 in one embodiment to provide an interface to additional devices, such as wireless devices 150. The wireless devices 150 may be sensors and actuators that are used to collect additional information from a particular location or locations in the process. For example, the measurement of temperature in various chambers of a cement kiln may be accomplished via an additional deployment of temperature sensors to augment the information provided by the existing sensors. While the fieldbus is designed to accommodate the deployment of such sensors, there may be instances where it is not convenient to provide wiring to the area needing sensing. Thus, the use of wireless devices provides added flexibility and capability in monitoring and control. The network abstraction device may be incorporated at many different parts of the system as will be seen in further exemplary embodiments below.

In further embodiments, needs, such as energy auditing and process diagnostics may also require the deployment of additional sensors such as field devices for example. Hazardous locations, mobile equipment and inaccessible locations may also give rise to a need for the use of wireless nodes.

The network abstraction device 145 comprises a radio frequency (RF) transceiver 155 in one embodiment, and an antenna 160 for communicating wirelessly with the wireless devices such as the wireless nodes 150, having corresponding transceivers with antennas 165. It may be appreciated by a person having ordinary skill in the art that the protocol generally used in such wireless communications may be any protocol providing sufficient bandwidth for the data that needs to be exchanged, and may also be compatible with providing information from the wireless devices that are consistent with the quality of service provided by the fieldbus 125. Further the network abstraction device 145 provides a wireless hotspot on the fieldbus network. The network abstraction device may act as a master for a cluster of wireless sensor nodes. Accordingly, it may be understood that the network abstraction device 145 is identified by a physical device tag/permanent address on the fieldbus network, just as are other physical devices.

The network abstraction device 145 also includes a protocol abstraction unit 155 that converts communications to a protocol that is consistent with that of the fieldbus protocol, which in one embodiment is a specified standard protocol. A complete fieldbus communication stack 175 is also included in the network abstraction device 145 for communicating directly with the fieldbus in the same manner as a fieldbus device.

The network abstraction device 145 ensures that wireless devices in one embodiment desirably behaves like a wired fieldbus device. This may make installation, maintenance, device addressing, device querying, service discovery and QoS (Quality of Service) essentially the same for the wireless nodes. In other words, the wireless nodes emulate fieldbus behavior without necessarily being fieldbus compliant devices. This emulation provides flexibility in adding different types of wireless sensors, such as pressure, flow, temperature, and others. The wireless devices are also thus able to interact with other devices in the fieldbus network.

By adding the wireless devices through a gateway type of device that implements the protocols used by the fieldbus, the existing network of hardwired devices is not disturbed due to the addition of the wireless devices. As the gateway emulates fieldbus device behavior, communications and data transfers may occur in conjunction with devices adhering to the fieldbus standards. This approach can provide a seamless integration/communication between wired and wireless devices over the fieldbus network.

In a further embodiment, the wireless nodes 150 may desirably build a network of wireless nodes coupled to the fieldbus network through the network abstraction devices 145. The wireless interface 155 is responsible for establishing a communication path between the wireless nodes in the network of wireless devices and the hardwired devices on the fieldbus network.

The wireless nodes in the wireless network can collectively perform a control action, and can share data with rest of the fieldbus network of devices. Alternatively, the devices in the wireless network can collaborate with the hardwired devices to perform a control operation.

In operation, the network abstraction devices 145 may be implemented in many different ways. A gateway may have many function blocks, and utilize a single address over the network. Wireless nodes may have the function blocks, and the gateway is addressed by a single address over the network. Gateways may have function blocks and each channel is referenced by a unique address over the network. In further embodiments, the wireless nodes have the function blocks, and each channel of the gateway is referenced by a unique address over the network.

Function blocks may be implemented in either the linking device 210, or the wireless devices. Implementation of more function in the linking device may burden it with additional responsibilities. However, implementation of more functions in the wireless devices may result in heavier consumption of power and potential reduction of battery life. This may lead to higher maintenance costs.

In a further embodiment shown generally at 200 in FIG. 2, the host system 110 is coupled to a linking device 210 that provides an interface to hardwired devices 130, 135, 140 through a fieldbus 125. It implements that standard fieldbus communication stack used in communicating with the hardwired devices. In addition, the linking device 210 also comprises a wireless interface 215 that includes an RF transceiver with antenna 220 for communicating with wireless nodes, devices, or network of wireless devices indicated at 150. A protocol abstraction unit 225 is included in linking device 210 for converting wireless communications to a proper protocol for enabling communication between the linking device and the wireless devices, and interfacing with the fieldbus communication stack to allow communications over the fieldbus 125 and to the host system 110.

In one embodiment, wireless interface device 215 operates in a master-slave mode, either single hop or multi hop, where the master sits in the linking device 210. Wireless devices 150 act as slave nodes. Thus, linking devices act as a master, and the wireless device act as slaves. This type of master/slave approach may also be utilized with respect to system 100 in FIG. 1. The number of slave nodes may vary depending on the protocols utilized. In this approach, the wireless interface 215 provides information to other devices in the network, which may use the information as desired.

When the linking device is interfacing with a network of wireless devices 150 in one embodiment, desirably ensures that the network of wireless devices ensures guarantees, and QoS comparable to that of the fieldbus network.

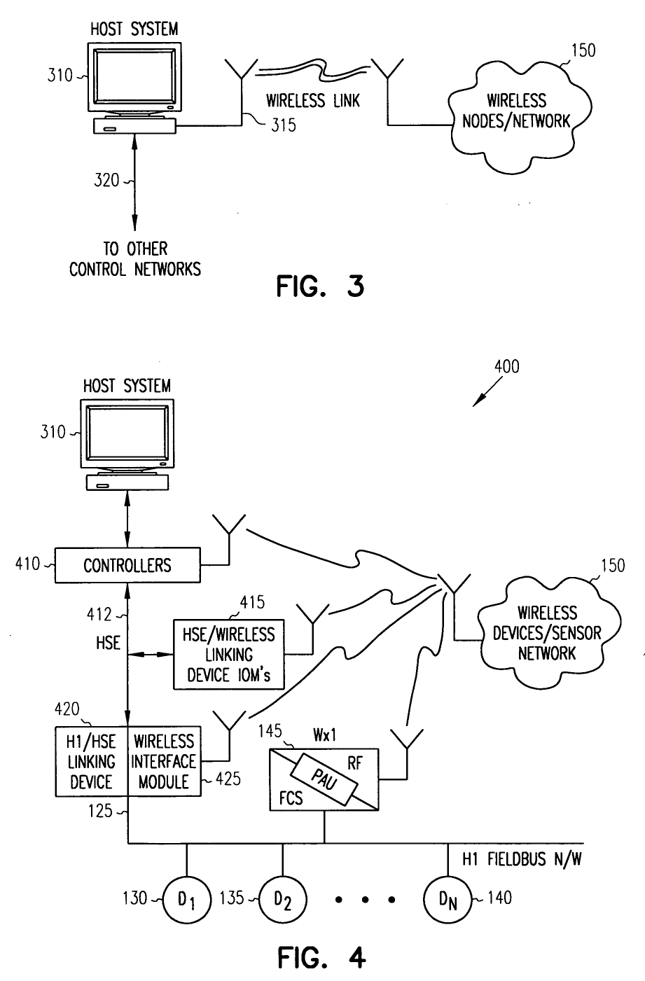

In a further embodiment, indicated generally at 300 in FIG. 3, a network of wireless nodes 150 is interfaced directly to a host controller 310 through a wireless interface 315. The host controller is further coupled to hardwired networks of devices via a bus 320, such as high speed Ethernet. The wireless device network 150 may be interfaced to the host 310 in a manner that emulates the behavior and guarantees offered by a convention wired network, such as a fieldbus network. The communication protocol of the network of wireless devices in combination with the wireless interface 315 is equivalent to that of the wired network in terms of QoS guarantees, reliability and determinism.

FIG. 4 depicts multiple stages at which wireless devices or networks 150 may be introduced into a system generally at 400. Host controller 310 in this embodiment is coupled to one or more controllers 410, which in turn are coupled to a high-speed bus 412, such as a high speed Ethernet. Controllers 410 may have integrated wireless interface modules for communicating with the wireless devices or networks 150. In some embodiments, a wireless linking device 415 may be coupled to the high-speed bus 412. A linking device 420 coupled to the high-speed bus 412 and the fieldbus 125 may have a wireless interface module 425 directly integrated or coupled to it. A wireless interface may be provided in the form of a gateway device 145 coupled directly to fieldbus 125. Still further, the host system may provide a wireless connection. These connections may be directly to wireless sensors, or networks of wireless sensors 150.

Wireless interfaces may be provided at multiple different stages. System 400 may have such interfaces at only one stage, or simultaneously at different stages. In one embodiment, each wireless interface interacts with wireless nodes or networks of devices, and provides a consistent level of reliability and QoS as that provided by the fieldbus devices. Each interface integrates such wireless devices into the bus to which it attaches. Hardwired protocols, for example, fieldbus protocols are abstracted in the wireless communication protocol.

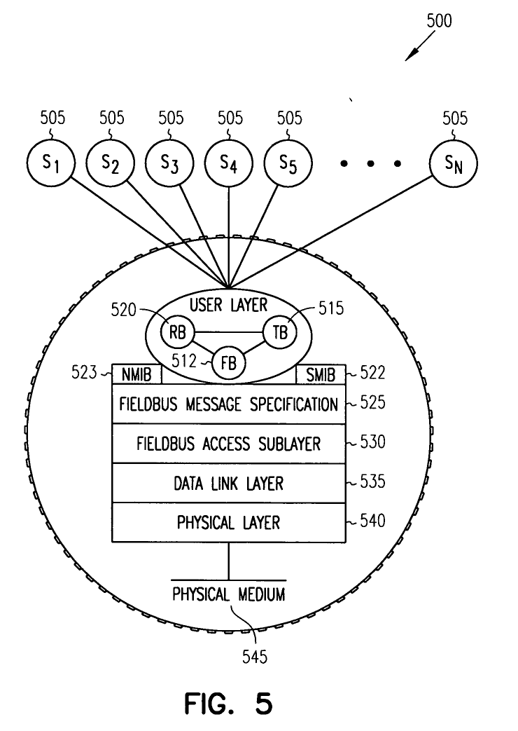

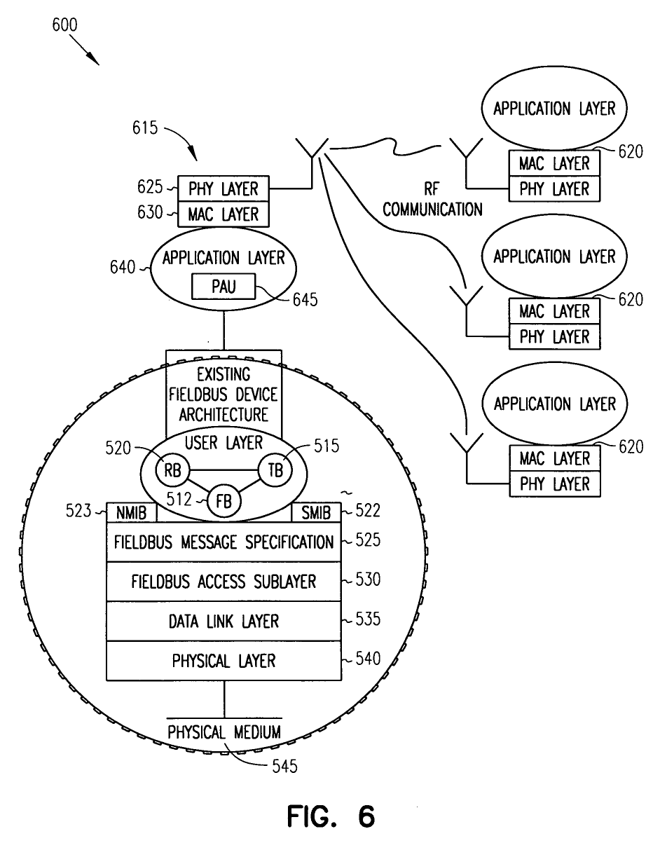

In one embodiment, fieldbus devices are compliant with the published FOUNDATION™ Fieldbus Specification. A conventional Fieldbus device is shown in FIG. 5 generally at 500. It may be capable of sensing multiple entities, like pressure, temperature, flow and others as indicated in the Specification. Thus, the architecture of the fieldbus device typically supports such multi sensing functionality as indicated by sensors 505. Generally a fieldbus device, may accommodate several channels to which data from various transducers can be fed into, such as by use of multi-channel transducer blocks as well as function blocks.

Generally, field device manufacturers provide the function blocks 512 along with the device. The various function blocks 512 supported by the device can be known from a Device Description File (DDF) stored in the device. However, the abstraction is maintained through a transducer block 515 and resource block 520. Transducer blocks and resource blocks abstract the I/O hardware of the devices from the function block software. The function blocks on the device can have a single channel and there could be multiple Transducer blocks, which can feed the transducer signal into the appropriate function block.

Transducer blocks 515 isolate function blocks 512 from the specific implementation details of transducers 505 for example sensors, actuators, etc). They also control the access to the transducers through a device independent interface defined for use by function blocks 512. Transducer blocks 515 convert the data from transducers 505 into a device independent format (performs calibration, linearization on I/O data). These blocks 515 provide an implementation independent interface to the function blocks 512 in the form of channels.

Execution in transducers is manufacturer specific. All parameters are defined as contained i.e. no defined function block links are provided for transducer parameters. The processed signal from input transducer blocks and the target position for output transducer blocks are referenced by channel number in associated function blocks. A transducer block typically might have one or more than one channel associated with it, or a device might even have several transducer blocks.

Resource blocks 520 on the other hand, describe the characteristics of the physical sub-component associated with a resource by a set of resource-contained parameters. The resource block 520 might contain parameters that are common to function blocks and transducer blocks.

Hardware specific characteristics of a field device 500 that are associated with a resource are made visible through the resource block 520. Similar to transducer blocks 515, they insulate function blocks 512 from the physical hardware by containing a set of implementation independent parameters. The resource block 520 also has an algorithm used to monitor and control the general operation of the resource. This algorithm may generate events and alarms that indicate problems associated with the resource as a whole. System management does not schedule the resource block algorithm execution.

Field device 500 further comprises a system management information base 522 and network management information base 523, and several communication layers, including the fieldbus message specification 525, a fieldbus access sublayer 530, data link layer 535, physical layer 540 which connects directly to physical medium 545 for transport of data. These are common abstraction layers in a communication protocol, such as that specified in the fieldbus specification.

A resource block may have execution that is manufacturer specific. All parameters are defined as contained i.e. no defined function block links are provided for resource block parameters. A test parameter may be provided in the resource block to allow the primitive data types defined by a fieldbus message specification 525.FMS and System Management to be read and written during interoperability testing.

In some cases, a function block 512 or transducer block 515 may use resource block 520 parameters; however the access is local in these cases. Transducer and resource blocks are generally implemented on any Foundation Fieldbus compliant device. This architecture is emulated on the gateway device for supporting multiple wireless nodes.

Another desirable property for the gateway device is that the nature of wireless nodes it supports should be dynamic (i.e., user should be able to add a pressure or temperature transducer dynamically).

The function blocks for the gateway devices in one embodiment support several channels so that different wireless sensor nodes can be connected to them via the transducer blocks. The gateway can be viewed as any other fieldbus device with multiple channels and the wireless nodes joining and leaving the fieldbus network is a matter of gateway channel activation The wireless interface (Master) on the gateway needs to be designed in such a way that, the wireless nodes (Slaves) can be connected through appropriate channels to the function blocks on the gateway.

The manufacturer can provide several transducer blocks to which different sensors/actuators can be connected. The manufacturer may also implement provision to accommodate the desired function blocks for these devices. In this scenario, each function block will have only one channel and is associated with the transducer block of the appropriate transducers.

A wireless sensor node joining/leaving the network is an issue of channel activation/deactivation. The architecture of the gateway device is shown in FIG. 6, with function and transducer blocks exhibiting the properties consistent with those in the fieldbus device. A superset DDF is used to dynamically update the DDF files when a new node joins the network (involves dynamic updating of resource block parameters as well). Dynamic association of the transducer block with the appropriate function block is also performed. All the fields/parameters in the DDF that are device specific are enumerated in the superset DDF. Thus the user can select the appropriate enumeration values during the commissioning of the device. The gateway device as and when a wireless sensor node joins uses this concept. Thus the flexibility to dynamically add different sensor nodes is provided.

Typically, in the DDF, one particular field specifies the total execution time of any given function block supported by that particular device. The function block execution time comprises of the transducer sampling time and the time taken by the algorithm executed by that particular function block. The value of this parameter however is static for a wired device. On the other hand, in case of a wireless device the function block execution time in addition to the above components should also consider the communication delay between the wireless nodes and the gateway device.

It may be apparent that if the type of wireless node joining the wireless gateway is dynamic, the respective transducer sampling time of these wireless nodes may also vary. Thus while updating the DDF file based on the type of wireless node joining the gateway, the function block execution time also needs to be accurately updated. The wireless protocol should address the issues of reliability and determinism over the communication medium.

A wireless protocol implemented in the gateway addresses these issues. However, any wireless protocol that can guarantee communication delays along with the reliability and determinism can be used for the purpose. A wireless interface 615 on the gateway typically acts as a master that controls wireless sensor nodes 620, which act as the slaves. A stack on the wireless interface comprises a physical layer 625, a Medium Access Layer (MAC) 630, and an application layer 640 whose basic responsibility (it can also provide few application specific services) is to multiplex the wireless nodes 620 with input channels of the function blocks or the transducer blocks.

Apart from that, the application layer 640 houses a Protocol Abstraction Unit (PAU) 645, which will abstract the wireless end from the function block architecture. The PAU need not exist on the wireless nodes. The PAU would do the functionalities of converting the wireless node data format into a format that is followed by the function blocks/transducer blocks on the fieldbus compliant side of the device. The PAU is also responsible to convert any information that needs to be passed from the fieldbus end to the wireless nodes through the interface.

The architecture of the wireless nodes 620 is the same as that of the wireless interface 615, it has a physical and a MAC layer which, may host a very low-end application layer (if required) that would perform certain application specific tasks.

In the fieldbus device architecture, the transducer block abstracts transducers from the function blocks and is responsible for feeding the transducer signal to the function blocks. The transducer block can execute as frequently as possible to read data from transducers. Writing the output to the actuators can be executed as needed to ensure the proper activation of the actuators.

In order to enable the usage of wireless nodes with the gateway, the transducer block is altered, which in present scenario communicates to local sensors and actuators, such that it communicate with the wireless sensor nodes. A wireless communication protocol that enables reliable communication between gateway and sensor/actuator nodes will replace I/O functions presently used by the transducer block to perform read/write operations on the hardwired sensor/actuators. As all the data originating from the sensors or destined towards the actuators passes through the gateway, a master slave (star) network can be formed. A wireless interface on the gateway will be the master and sensor/actuator nodes would be the slave nodes.

In order to enable contention less media access, a Time Division Multiple Access (TDMA) scheme may be implemented. Each sensor/actuator node is allocated a guaranteed time slot, which can be used only by that node. Assume that, maximum number of sensor/actuator nodes that will be interfaced to a gateway is n and the fastest sampling sensor samples at every t units of time. The communication super-frame, defined as the time interval during which every node communicates once to the master node, is selected to be of duration t/2. This ensures that each data sample, even from the fastest sensor, is received twice.

The super-frame will be divided into n+0.5n slots; i.e., if maximum nodes to be accommodated are 8, the super-frame would have 12 slots. All the nodes will have a slot from the super-frame allocated to each of them, whereas, remaining slots will be used for network management, diagnostic, event management, or other non-critical communication which can be polling or contention based.

Duration for each slot would be sufficient for exchanging one data frame & its acknowledgement and one retransmission attempt if the acknowledgement is not received. Baud rate, communication channel bandwidth & other related physical layer parameters would be selected appropriately (time synchronization is maintained between the wireless master on the gateway device and the slave nodes).

In each data frame, a sensor node will typically send its recent data, its identification number (address), gateway ID (Gateway's address), timestamp, any additional information required to use & decode the data in a secured manner. The packet will have a CRC appended to it for the purpose of error detection.

Each data frame sent to actuator will typically comprise the node identification (address), actuation data, gateway ID (Gateway's address), timestamp & any additional information required to use & decode actuation data. This also would be a secured communication.

The physical layer provides the actual means of communication even in presence of interferences and issues related to multi-path fading arising due to the presence of highly reflecting steel and metal structures in the industrial environment. In one embodiment, the nodes will use Frequency Hopping Spread Spectrum technique, as it provides immunity to interferences present in industrial scenario. The nodes will have tunable narrow band radio operating in either of ISM bands (915 MHz or 2.4 GHz) or in a licensed frequency band. The available band is divided into multiple channels in such a way that each channel has enough bandwidth to communicate at required baud rate.

Available band may be divided into a few sub-bands such that bandwidth of a sub-band will be more than bandwidth of any wide band interference source present in the industry. Assuming that the frequency band used for the wireless communication can be divided into m sub-bands & p channels, there will be q channels in each sub-band, where q=p/m.

The channel hopping sequence of each node may be such that it hops at least by q channels after each transmission/re-transmission. After every transmission, the node pseudo-randomly selects one channel from q channels available in each sub-band, and one sub-band from available m sub-bands. It uses the selected channel of the selected sub-band for the next transmission/re-transmission. The algorithm used for pseudo-random channel selection ensures that the gap between the two channels used for any successive communications from a node will be always greater than q.

The seed used for pseudo-random number generator used in the pseudo-random channel selection algorithm at a node may be randomly generated by the master node and may be conveyed to the node at the time of association. The seed and some other information shared by the node and master will be used for random number generation. Thus, the channel/sub-band number selected for next communication is a function of present channel/sub-band number, seed, shared information & pseudo-random channel selection algorithm. This ensures that the channel sequence used by each channel will be different than that of any other node from the same or different gateway network.

This manner of frequency hopping will ensure that if one transmission fails because of interference, the re-transmission will mostly succeed because it happens in a well separated channel. The randomness of the hopping channels also ensures that all channels of the band are uniformly used over a given period of time, which is a FCC requirement.

The master & slave devices know frequency hopping patterns of each other because all the information used for selecting the channel used for next communication is shared by them. The receiver and transmitter nodes tune into the appropriate frequency at the beginning of the communication slot.

The pseudo-random FHSS protocol allows laying overlapping gateway networks without interfering each other. If ISM bands are used, the large bandwidth of the ISM bands may help to provide large number of channels and sub-bands. As the nodes select one of the many available channels, the probability of selection of the same channel is extremely rare. Therefore, the overlapping gateway networks will function with negligible collisions and inter-network interference. Even if a transmission from two nodes of neighboring networks collides, due to the pseudo-random mechanism used to select the channel used for next communication, the re-transmission will succeed. Thus, the interference among the wireless nodes of different networks will be minimized.

The multi-path fading is result of superposition of multiple RF waves reaching the receiver in different paths. This effect depends on wavelength of the wave, distance between the transmitter & receiver and amount & nature of reflectors present in the area. This effect leads to formation of blind spots in the area of communication. A node cannot communicate with the other nodes residing in its blind spot areas.

The blind spot pattern depends on the frequency. A blind spot at a particular frequency can be well covered by another well-separated frequency. This fact will be used to combat the fading issue. The nodes will have RF front ends capable of transmitting and receiving at two well-separated frequencies, simultaneously. The other frequency will always be 2q+apart from the first frequency. The same data is transmitted in two different channels so that, even if transmission in one channel fails to reach the receiver node due to fading, transmission in the other channel will mostly succeed.

Once the wireless nodes get associated and a slot is allocated to each of them, they can go in power down mode to conserve energy and wake up only during their slots. The reduced power consumption will enable deploying battery powered nodes in the network.

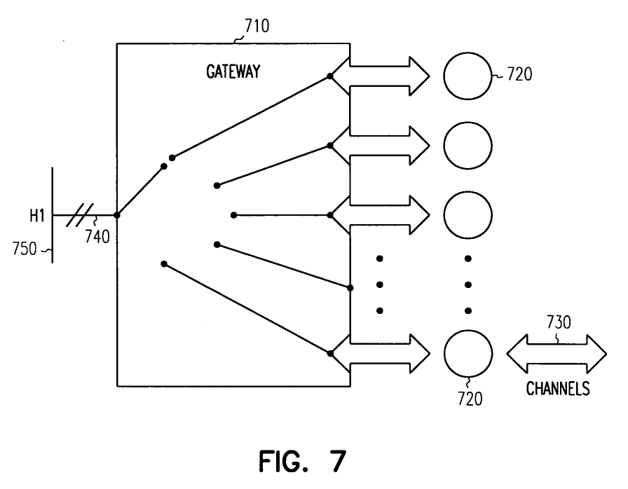

FIG. 7 is a block diagram of an architecture for a gateway 710 with multiple wireless nodes 720. It is used to represent at least four different architectures, including a gateway with function blocks and a single address over the network, wireless nodes with function blocks and a single address over the network, gateway with function blocks and multiple addresses over the network, and wireless nodes with function blocks and multiple addresses over the network.

Function blocks may be located either in gateways or wireless nodes. In one embodiment, where the gateways have the function blocks, and a single address 740 over the network 750, wireless nodes joining and leaving the Fieldbus network is an issue of channel 730 activation. More importantly, the gateway 710 along with the wireless nodes would share the same address 740 over the network. Nevertheless individual wireless nodes can be still referenced by their respective channel references. The architecture of the gateway device and the wireless nodes would be identical to the core architecture discussed in the previous section. Also, the wireless protocol architecture would remain unchanged.

In a further embodiment, the wireless nodes implement the function blocks. The wireless nodes themselves execute the appropriate function block on the measured process variables and feed the end result to the network via the PAU on the gateway device. The gateway device would be a mere translator between the wireless media and the fieldbus network. Nonetheless, the gateway would also act as a facilitator to enable interaction between the function blocks residing on different wireless nodes subject to blind spots if any.

In a further embodiment, the gateway has the function blocks, but also is addressed by multiple addresses over the network, also represented by line 740. This form is identical to that of the first architecture above, except that each channel associated with a wireless node can be referenced by a unique address over the fieldbus network. Every wireless node would be looked upon as an independent device over the network with a unique address over the link. However, to implement this feature enough support needs to be provided at a System Management Kernel (SMK) level as it involves maintaining a unique System Management Information Base (SMIB) associated with each channel that needs to have an independent address over the Fieldbus network. Also, the Network Management Information Base (NMIB) for each channel needs to be provided.

Inter wireless node communication in this case will happens via the gateway. In other words, each wireless node interacts with other wireless nodes using the unique addresses which they posses over the network. This mechanism would eliminate potential issues of responding to multiple probe node messages during the system expansion and initial configuration stages of deployment.

In yet a further embodiment, the function blocks reside on the wireless nodes, and there are multiple addresses used over the network. Unlike the above modes of realization, the function blocks in this form are implemented over the wireless nodes. The architecture of the gateway device remains identical to the core architecture described in the previous section with a few exceptions. The first being, a separate SMIB (probably the same case with the Network Management Agent (NMA) and the Network Management Information Base (NMIB)) might be required for each addressed channel. Secondly, the gateway itself should have a special address over the network.

This section explains about the installation and commissioning of the wireless nodes. The nodes can join/leave the network in a dynamic manner. An effective and efficient approach is used to educate the host system on inclusion of these devices onto the existing network. The following steps work towards achieving such installation and commissioning.

The gateway device once hooked onto the Fieldbus network chooses a temporary address over the network and waits for the probe node messages from the LAS (Link Active Scheduler). Once, it responds to the probe node with a probe response message. The gateway is visible to the host system with some bare minimal information. Now since the channels on the gateway are not yet activated (no wireless node is attached to the gateway) and moreover the type and role of the wireless node is not decided at this stage, this drives the necessity for a dynamic approach for the host system to know about the detailed description of the gateway along with the information about its channels.

Initially the gateway is commissioned using a universal device description file (DDF), with the device specific parameters of all the devices supported by the gateway enumerated. A Physical Device-Tag and physical address are assigned to the gateway. Whenever a wireless node joins the network, the wireless interface assigns a channel to it and gateway responds to the probe node messages sent by the LAS. The LAS/LD (Linking Device) may treat the Gateway Device as a special device and allow it to respond to multiple probe nodes depending upon the number of wireless devices joining the gateway.

The user can now configure the gateway along with the appropriate channels and function blocks by choosing the appropriate fields from the enumerated DDF. The host system can now use the device appropriately.

An alternate approach to DD file updating is to use a deterministic gateway, which specifies the type and role of the wireless sensor nodes that would be connected to its channel. The device leaving the network would be identical to that of the wired device as described in the previous section.

A linking device approach is identical to the gateway approach except that the wireless interface is housed on the linking device. Apart from that, the fieldbus stack architecture on the linking device should also provide the application layer that encompasses the Function Block architecture. The rest of the wireless protocol and the PAU details remain unchanged.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A distributed process control system comprising:
a plurality of first field devices for sensing a first information set corresponding to industrial process control parameters, the first field devices channeling the first information set through a wired first channel;
a plurality of second devices being characterized as wireless nodes to sense a second information set corresponding to the distributed process control parameters, the second devices being coupled to a plurality of first wireless transceivers to channel the second information set through at least one wireless channel to the wired first channel for augmenting the industrial process control pertaining to said distributed control system architecture;
at least one host controller electronically accessing and processing primary information characterizing the distributed control system and secondary information corresponding to the first and second information sets; and
a network abstraction device coupled to a least one second wireless transceiver wirelessly communicating with the first wireless transceivers, said network abstraction device being configured to emulate a communication gateway.

2. The device of claim 1, wherein the network abstraction device comprises:
means for abstraction of a wireless protocol;
means for interfacing with the wireless channel; and
means for abstracting communication through the wired first channel.

3. The device of claim 1, wherein the network abstraction device is compliant with communication protocols controlling communication through the wired first channel as well as the wireless channel.

4. The device of claim 1, wherein the network abstraction device provides a wireless channel for each wireless device.

5. The device of claim 1, wherein the wireless protocol comprises a radio frequency hopping protocol.

6. A network abstraction device comprising:
a wireless interface device for communicating with wireless devices;
a protocol abstraction unit to translate data between formats for the wireless interface devices and a hardwired bus; and
a communication stack coupled to the protocol abstraction unit and hardwired bus for emulating data communication through said hardwired bus having a plurality of hardwired bus devices.

7. The device of claim 6, wherein the bus comprises a fieldbus compliant with a FOUNDATION™ Fieldbus specification.

8. The device of claim 6, wherein the network abstraction device communicates with a plurality of wireless nodes.

9. The device of claim 8, wherein the wireless nodes are configured to form a wireless network.

10. The device of claim 6, further comprising a linking device for coupling to a host controller and to the bus for communicating with the hardwired bus devices.

11. The device of claim 10, wherein the network abstraction device and the linking device are configured to be integrated together.

12. The device of claim 6, wherein the wireless interface device is adapted to implement an radio frequency hopping protocol for communicating with the wireless nodes.

13. The device of claim 6, wherein the wireless interface device comprises:
a physical layer;
a media access control layer; and
an application layer.

14. The device of claim 13, wherein the wireless interface device further comprises:
a resource block;
a transducer block;
function blocks; and
multiple communication layers for coupling to a physical medium of the bus comprising a fieldbus.

15. The device of claim 14, wherein the network abstraction device is responsive to multiple communication addresses corresponding to each of the wireless node.

16. The device of claim 6 wherein the network abstraction device is deterministic with respect to a type and role of wireless devices with which it communicates.

17. A system comprising:
a plurality of first field devices;
a hard wired bus coupled to the plurality of first field devices;
a plurality of second field devices; wherein said second field devices are configured to form a wireless network;
a wireless bus coupled to the plurality of second field devices;
means for interfacing the wireless bus to the hardwired bus; and
means for abstracting communication through said hardwired bus.

18. The distributed process control system of claim 15, wherein the means for interfacing the wireless bus to the hardwire bus further comprises a transducer block, a resource block and a function block.

19. The distributed process control system of claim 15, wherein the transducer block is adapted to isolate the function block from physical specifications of the plurality of second devices through a device independent interface.

20. The distributed process control system of claim 15, wherein the transducer block is adapted to convert the field device device data into a device independent format.

21. The distributed process control system of claim 15 wherein the transducer block is adapted to perform calibration and linearization on the field device data.

22. The distributed process control system of claim 15 wherein the resource block is adapted to provide a set of resource constrained parameters.

23. The distributed process control system of claim 15 further comprising multiple transducer blocks supporting several channels for coupling to the second set of devices.

24. The distributed process control system of claim 15 further comprising multiple function blocks supporting several channels for coupling to the second set of devices.

25. The distributed process control system of claim 15, wherein the means for interfacing the wireless bus to the hardwire bus comprises a linking device coupled between the hardwired bus and a high speed bus coupled to a host controller.

26. The distributed process control system of claim 15 wherein the means for interfacing the wireless bus to the hardwired bus is configured to ensure that quality of service and reliability of the second plurality of devices are consistent with the plurality of first devices.

27. The distributed process control system of claim 15 wherein the plurality of second devices comprise sensors independent of the first plurality of first devices.

28. A device implemented method comprising:
communicating with a plurality of wireless sensors monitoring a process;
emulating a device coupled to a hardwire bus; and
providing a quality of service for communications from the wireless nodes consistent with a quality of service provided on the fieldbus with respect to device coupled hardwired therewith

29. The method of claim 28, wherein the hardwire bus comprises a fieldbus compliant with a FOUNDATION™ Fieldbus specification.

30. The method of claim 28, wherein the device implementing the method comprises a network abstraction device coupled directly to the fieldbus.

31. The method of claim 28, wherein the device implementing the method comprises a linking device coupled to a host controller and to the fieldbus.

32. The method of claim 28, wherein the device implementing the method comprises a host controller.

33. The method of claim 28 wherein the device specifies a type and role of wireless sensor nodes it communicates with via a channel.
